(19) United States
(12) Patent Application Publication
(10) Pub. No.: US 2012/0089450 A1
(43) Pub. Date: Apr. 12, 2012

(54) LOYALTY OFFER

(75) Inventors: Anoop Anantha, Kirkland, WA (US); Murali R. Krishnan, Clyde Hill, WA (US)

(73) Assignee: MICROSOFT CORPORATION, Redmond, WA (US)

(21) Appl. No.: 12/899,861

(22) Filed: Oct. 7, 2010

(51) Int. Cl. G06Q 30/00

(52) U.S. Cl. 705/14.23; 705/26.1; 705/27.1; 705/14.4; 705/1.1

(57) ABSTRACT

Loyalty offer techniques are described. In one or more implementations, data is received from a plurality of merchants via a network, the data describing transactions for goods or services initiated at physical locations of respective said merchants and including identifiers that uniquely identify mobile communication devices that were used to initiate the transactions. Information is updated that describes participation in one or more loyalty offers associated with the plurality of merchants using the identifiers that uniquely identify the mobile communication devices and the data that describes the transactions.

### BACKGROUND

Mobile communication devices such as wireless phones have become a common part in the everyday life of a wide variety of users. Consequently, the mobile communication device may serve as a primary point of contact for a variety of business and personal uses. For example, a business user may utilize the mobile communication device to receive email, a casual user may send text messages to friends, either one of the users may share pictures, and so on.

However, traditional techniques that were employed to securely store data on the mobile communication device as well as to communicate data to the mobile communication device could result in the data being “in the clear.” Even if but for a brief moment in time, malicious parties may take advantage of this vulnerability to steal sensitive data. This may even result in the ability by the malicious party to access other information on the mobile communication device itself. Consequently, functionality of the mobile communication device may be limited from meeting its true potential due to the ability to compromise data on the mobile communication device.

### SUMMARY

Loyalty offer techniques are described. In one or more implementations, data is received from a plurality of merchants via a network, the data describing transactions for goods or services initiated at physical locations of respective merchants and including identifiers that uniquely identify mobile communication devices that were used to initiate the transactions. Information is updated that describes participation in one or more loyalty offers associated with the plurality of merchants using the identifiers that uniquely identify the mobile communication devices and the data that describes the transactions.

In one or more implementations, an input is received to initiate a transaction to purchase a good or service. One or more credentials are transmitted to a merchant to purchase the good or service and an identifier that is usable in conjunction with a loyalty offer associated with the merchant.

In one or more implementations, a mobile communication device comprises one or more modules that are configured to provide telephone functionality including an ability to make and receive telephone calls. The modules are also configured to communicate one or more identifiers at a physical location of a merchant that are to be used to identify participation in one or more loyalty offers associated with the merchant, the one or more identifiers stored locally in memory of the mobile communication device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example implementation of a mobile communications device in communication with a marketplace in accordance with one or more embodiments of devices, features, and systems for mobile communications.

FIG. 2 is an illustration of a system in an example implementation in which a mobile communication device of FIG. 1 interacts with a merchant to purchase a good or service and participate in a loyalty offer.

FIG. 3 is a flow diagram depicting a procedure in an example implementation in which a user offer is generated by a loyalty service based on data received from a merchant.

FIG. 4 is a flow diagram depicting a procedure in an example implementation in which a mobile communication device provides credentials and an identifier to initiate a purchase of a good or service and participate in a loyalty offer.

FIG. 5 is a flow diagram depicting a procedure in an example implementation in which data that describes participation in a loyalty offer is managed by a loyalty service.

FIG. 6 illustrates various components of an example device that can be implemented in various embodiments as any type of a mobile device to implement embodiments of devices, features, and systems for mobile communications.

### DETAILED DESCRIPTION

Overview

Loyalty offers may be used by merchants to promote business with the merchant. For example, a merchant may offer a discount for a purchase of gas for every “X” amount of groceries purchased, offer an 11^{th} cup of coffee free after purchase of ten cups, a discount based on a dollar amount of purchased media, and so on. In this way, a consumer may be incentivized to purchase goods or services from a particular merchant.

However, a consumer may be confronted with a variety of different loyalty offers from a variety of different merchants. Further, the different merchants may employ different techniques to track the consumer's loyalty in relation to qualifying for the offer, such as punch cards, magnetic swipe cards, and so on. Consequently, a user may be confronted with a wide variety of different types of cards that may consume a limited amount of space in the user's wallet. Thus, this may be inefficient and interfere with the user's ability to participate with the loyalty offers.

Loyalty offer techniques are described. In implementations, a mobile communication device (e.g., a mobile phone) is utilized to maintain data related to participation in one or more loyalty offers. For example, the mobile communication device may be configured to maintain an “electronic wallet” that includes credentials to purchase goods or services. The wallet may also be configured to maintain identifiers that may be communicated with the credentials to participate in a loyalty offer. In this way, a user may efficiently interact with merchants to purchase goods or services as well as participate in loyalty offers of the merchant. The loyalty techniques described herein may be leveraged to offer a variety of other functionality, such as to support generation of user profiles, further discussion of which may be found in relation to the following sections.

In the following discussion, a variety of example implementations of a mobile communication device (e.g., a wireless phone) are described. Additionally, a variety of different functionality that may be employed by the mobile communication device is described for each example, which may be implemented in that example as well as in other described examples. Accordingly, example implementations are illustrated of a few of a variety of contemplated implementations. Further, although a mobile communication device having one or more modules that are configured to provide telephonic functionality are described, a variety of other mobile devices are also contemplated, such as personal digital assistants, mobile music players, dedicated messaging devices, portable game devices, netbooks, and so on.

Example Implementations

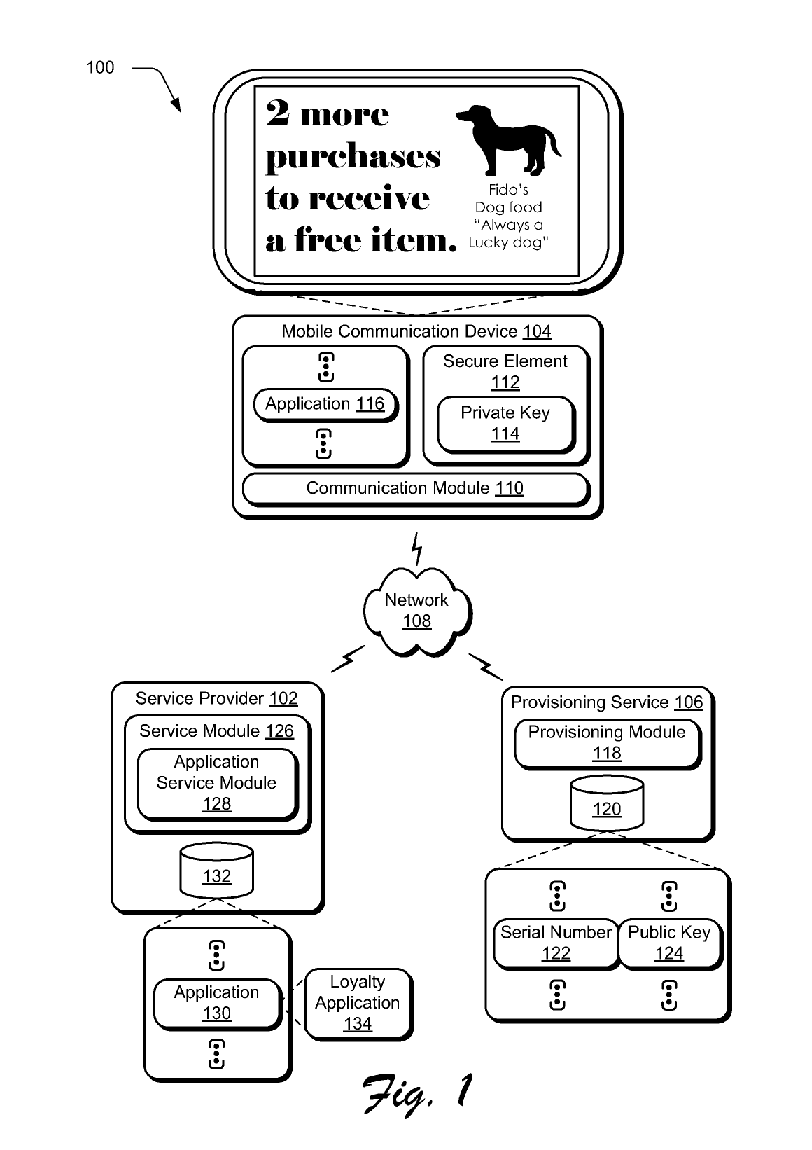

FIG. 1 is an illustration of an example implementation of an environment 100 that is operable to employ the techniques described herein. The environment includes a service provider 102, a mobile communication device 104, and a provisioning service 106 that are illustrated as communicatively coupled, one to another, via a network 108. Although the network 108 is illustrated as the Internet, the network may assume a wide variety of configurations. For example, the network 108 may include a wide area network (WAN), a local area network (LAN), a wireless network, a public telephone network, an intranet, and so on. Further, although a single network 108 is shown, the network 108 may be representative of multiple networks.

The mobile communication device 102 is further illustrated as including a communication module 110. The communication module 110 is representative of functionality of the mobile communication device 102 to communicate via the network 108. For example, the communication module 110 may include telephone functionality to make and receive telephone calls, such as by employing a telephone module to communicate via a plain old telephone service (POTS), wireless network (e.g., cellular and/or Wi-Fi), and so on.

The communication module 110 may also include a variety of other functionality, such as to capture content, form short message service (SMS) text messages, multimedia messaging service (MMS) messages, emails, status updates to be communicated via a social network service or micro-blog, and so on. For instance, the communication module 110 may also support browser functionality to browse the network 108.

The mobile communication device 104 is further illustrated as including a secure element 112. In one or more implementations, the secure element 112 is representative of functionality to support secure communications with the mobile communication device 104. The secure element 112 may be implemented using hardware and configured during manufacture to include a private key 114 and a variety of other keys. For instance, the secure element 112 may be implemented using a tamper-resistant integrated circuit that is resistant to “snooping” as well as physical removal from the mobile communication device 104 by a manufacturer of the device. For example, the manufacturer may cover a surface-mounted integrated circuit with an epoxy that helps to prevent snooping of the circuit as well as causing the circuit to break if removal is attempted.

In implementations, the secure element 112 includes functionality to perform encryption and/or decryption operations. For example, the secure element 112 may use the private key 114 to perform a decryption operation and expose a result of the operation to other functionality of the mobile communication device 104, such as to one or more applications 116 that are executable by the mobile communication device 104. In this example, the secure element 112 may receive data to be decrypted from the application 116, decrypt the data using the private key 114, and then expose a result of the decryption operation (i.e., the decrypted data) to the application 116. Therefore, inclusion of the private key 114 in the secure element 112 may help to protect the private key 114 from discovery “outside” the secure element 112 by keeping the private key 114 from being exposed “in the clear” during the decryption operation.

A variety of other functionality may also be supported through use of the secure element 112. For example, the secure element 112 may support a protected communication channel through the provisioning service 106. The provisioning service 106, for instance, may include a provisioning module 118 and storage 120. The storage 120 may be used to maintain a serial number 122 assigned to an integrated circuit that includes the secure element 112 and a corresponding public key 124 that forms an asymmetric public/private key pair with the private key 114 of the mobile communication device 104. The provisioning module 118 may thus provide the public key 124 to third-party services such that communication between the third-party service and the mobile communication device 104 is protected, even if that communication occurs using the provisioning service 106 or other service as an intermediary.

For example, a user of the mobile communication device 104 may interact with the communication module 110 or other functionality (e.g., an application 116) to navigate to a service provider 102 over the network 108. The service provider 102 as illustrated includes a service module 126 that is representative of functionality to provide one or more services for access via the network 108.

An example of one of these services is illustrated as implemented by an application service module 128. The application service module 128 is representative of functionality to manage dissemination of one or more applications 130 via the network 108. Although the applications 130 are illustrated as stored in storage 132 local to the service provider 102 (e.g., as part of a server farm that implements the service provider 102), the storage 132 may be representative of a wide variety of different types of storage, e.g., third party storage.

In an example, the application service module 138 manages a marketplace configured to provide applications 130 for purchase via the network 108. Therefore, a user of the mobile communication device 104 may access the marketplace to purchase one or more of the applications 130 for download to local storage, which is illustrated as application 116 in this example. To purchase and/or transport the application 130, the mobile communication device 104 and the service provider 102 may utilize secure communications implemented at least in part through use of the secure element 112. The secure communications may be implemented in a variety of ways.

In one instance, the public key 124 is provided to secure communications between the service provider 102 and the mobile communication device 104 directly. For example, the public key 124 may be located by the provisioning module 118 of the provisioning service 106 by obtaining a serial number 122 for the integrated circuit that implements the secure element 112, e.g., from the mobile communication device 104. The provisioning module 118 may then use the serial number 122 to locate the public key 124 and provide the public key 124 to the service provider 102. The public key 124 may then be used to encrypt data to be communicated to the mobile communication device 104, such as the application 130, billing information and other credentials, and so on.

In another instance, the provisioning service 106 provides the public key 124 to the service provider 102 as a basis to support indirect communications, such as to securely transport credentials and other data (e.g., cryptographic keys) that are to be used as a basis to form a communication channel. For example, the service provider 102 may provide credentials (e.g., other cryptographic keys) that are to be used to secure communications between the service provider 102 and the mobile communication device 104. To protect these credentials from compromise by malicious parties, the credentials may be encoded using this public key 124. In other words, the other cryptographic keys may be encrypted using the public key 124 for communication to the mobile communication device 104 to protect the other cryptographic keys from discovery by malicious parties.

In this way, regardless of whether the communication is communicated indirectly via the provisioning service 106 or directly via the network 108, the credentials (e.g., the other cryptographic keys) are protected from discovery through encryption using the public key 124. Therefore, even the provisioning service 106 itself is not able to determine “what” is being communicated between the service provider 102 and the mobile communication device 104.

The mobile communication device 104 may then decrypt the communication using the secure element 112, and more particularly the private key 114, to obtain the other cryptographic keys. A variety of different techniques may then be employed to utilize the other cryptographic keys once decrypted. 100311 In one technique, the other cryptographic keys are exposed for use outside the secure element 112, such as by an application 116 or other functionality of the mobile communication device 104. Thus, in this techniques the secure element 112 is leveraged to provide the credentials that are used to serve as a basis to secure communications but is not used to secure the communications itself, i.e., to provide the actual encryption/decryption.

In another technique, the other cryptographic keys may be kept from being exposed outside the secure element 112 through storage within the secure element 112. The secure element 112 may then use the cryptographic keys as previously described to decrypt and/or encrypt data received by the secure element 112 without exposing the cryptographic keys “outside” the secure element 112. The secure element 112 may thus employ a variety of different techniques to secure communications with the mobile communication device 104, the example of the service provider 102 above being but one of many such examples.

The secure element 112 may be leveraged to provide a variety of different functionality. For example, a user of the mobile communication device 104 may navigate to the service provider 102 to obtain a loyalty application 134. The loyalty application 134 may be provided by a merchant to promote business with a merchant, such as to implement a loyalty offer (e.g., a rewards program) and other functionality that may be beneficial to the user. The loyalty application 134 may then be communicated to the mobile communication device 104 and provisioned using the techniques previously described in conjunction with the provisioning service 106. For instance, an identifier may be communicated and stored at the mobile communication device 104 using the secure communication techniques described above, e.g., within the secure element 112 or elsewhere in memory. In this way, the mobile communication device 104 may be configured to maintain data that may be used in conjunction with a loyalty offer on the mobile communication device 104. Further, the loyalty application may be used to track participation with one or more offers, an example of which is illustrated as output via a user interface on the mobile communication device 104. A variety of other examples are also contemplated, further discussion of which may be found in relation to the following figure.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof In the case of a software implementation, the module, functionality, or logic represents program code that performs specified tasks when executed on a processor (e.g., CPU or CPUs). The program code can be stored in one or more computer readable memory devices, such as random access memory, read only memory, hard disk drives, optical discs, flash drives, and so on. The features of the loyalty offer techniques described below are platform-independent, meaning that the techniques may be implemented on a variety of commercial computing platforms having a variety of processors.

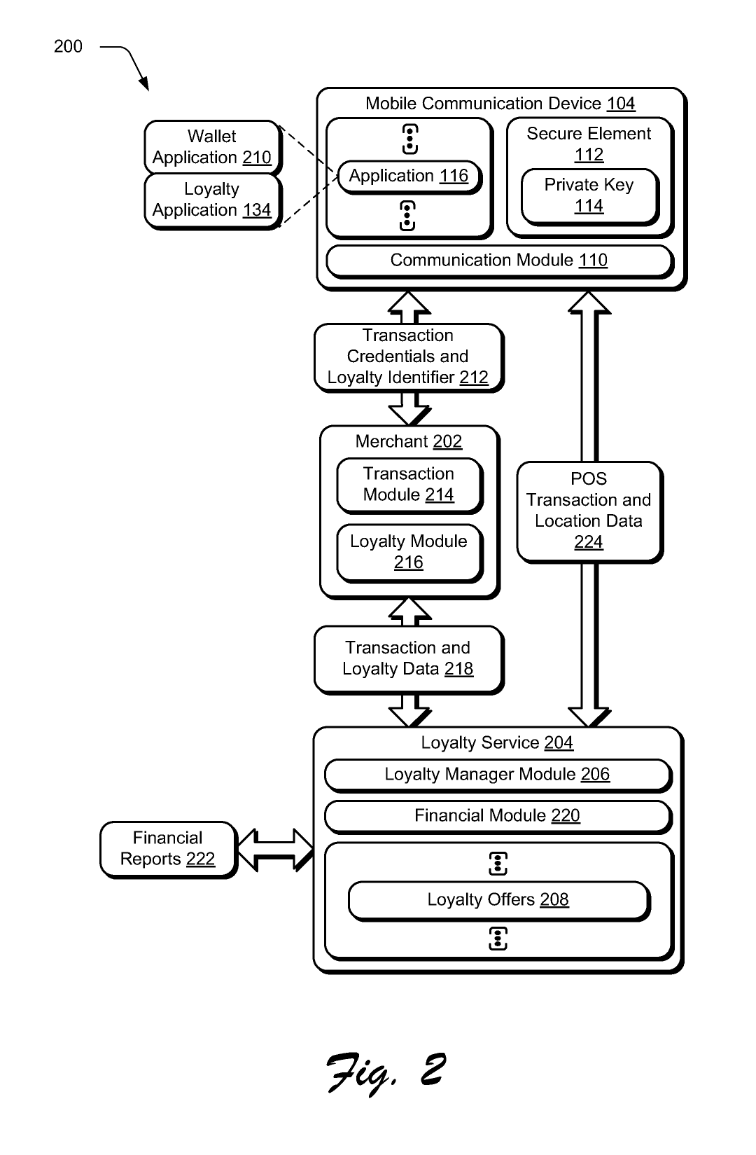

FIG. 2 depicts a system 200 in an example implementation in which a mobile communication device 104 interacts with a merchant to purchase a good or service and participate in a loyalty offer. The system 200 as illustrated includes the mobile communication device 104 as well as a merchant 202 and a loyalty service 204.

The loyalty service 204 may be implemented in a variety of ways, such as a stand-alone service, part of the provisioning service 106, and so on. The loyalty service 204 is further illustrated as including a loyalty manager module 206 that is representative of functionality to maintain one or more loyalty offers 208. Loyalty offers 208 may be configured in a variety of ways. For example, the loyalty offer 208 may specify a unit of loyalty, such as a number of purchases, a dollar amount, purchase frequency, and so on.

The loyalty offer 208 may also specify a threshold for an action relating to loyalty, such as 5 purchases to get a ten percent discount. These offers may be generated in a variety of ways, such as based on data received from the merchant 202, through entry in a user interface that is exposed via a network, and so on. The loyalty service 204 may then be used to manage the loyalty offer 208, an example of which follows.

As previously described, the mobile communication device 104 may execute a variety of different applications 116, such as the loyalty application 134 previously described, a wallet application 210, and so on. The wallet application 210, for instance, may be configured to operate in conjunction with the secure element 112 to provide credentials to the merchant to purchase a good or service. Likewise, the loyalty application 134 may be configured to provide an identifier that may be used to track participation of a user of the mobile communication device 104 with the loyalty offer 208.

The identifier may be configured in a variety of ways, such as a unique identifier assigned by the loyalty service 204 (e.g., that matches a number on a plastic magnetic swipe card), a unique identifier of the mobile communication device 104 itself, and so on. Additionally, the loyalty identifier may be stored in a variety of locations, such as in general memory of the mobile communication device 104, within the secure element 112, and so on. In this way, the mobile communication device 104 may serve as an “electronic wallet” to maintain identifiers related to loyalty offers as well as to facilitate purchases.

For instance, the mobile communication device 104 may be carried by a user of the mobile communication device 104 to a physical location of the merchant 202, such as a traditional “bricks and mortar” store. The mobile communication device 104 may then be used to communicate transaction credentials (e.g., credit card information, a user login and password, and so on) and a loyalty identifier 212 to the merchant 202 to initiate the transaction. The transaction credentials and loyalty identifier 212 may be communicated in a variety of ways, such as by using near field technology to communicate wirelessly over a short distance, via a Wi-Fi network, via a cellular network, and so on.

The merchant 202 may then continue processing the transaction credentials and the loyalty identifier 212 to complete the purchase as well as to process participation with the loyalty offers 208. For example, the merchant 202 may employ a transaction module 214 that is representative of functionality to complete a purchase of a good or service. Likewise, the merchant 202 may employ a loyalty module 216 to process data describing participation of the mobile communication device 104 with one or more loyalty offers. Thus, in this example the merchant 202 may perform processing for the transaction and/or the loyalty service.

The merchant 202 may also employ the loyalty service 204 to perform this processing. For example, the merchant 202 may communicate transaction and loyalty data 218 to the loyalty service 204 over a network. The loyalty service 204 may then employ a loyalty manager module 206 to manage participation with the loyalty offer 208. Likewise, the loyalty service 204 may also include a financial module 220 that may be configured to process transactions, generate financial reports 222 describing the transactions (e.g., for processing by another service), and so on. Further, these techniques may be provided to a plurality of different merchants for a plurality of different loyalty offers. Thus, the loyalty service 204 in this example may act as a centralized point (e.g., a clearinghouse) to manage loyalty offers 208 of merchants 202. Such a service may be provided to the merchants for a fee.

Further, although communication through the merchant 202 with the loyalty service 204 was described, direct communication between the mobile communication device 104 and the loyalty service 204 may also be supported. For example, the mobile communication device 104 may communicate point of sale (POS) transaction and location data 224 to the loyalty service 204. This data may then be used to manage participate with the loyalty offers 208. Further, this data may also be used to model user preferences of the mobile communication device 104. For example, the loyalty manager module 206 may include functionality to model which offers were utilized by the mobile communication device 104.

Yet further, this modeling may even serve to track other user behavior in relation to the loyalty offers 208. For example, the loyalty manager module 206 may track other purchases made by the mobile communication device 104, even if the purchases do not correspond to one or more of the loyalty offers. In this way, the loyalty service 204 may determine that the loyalty offers 208 were successful at getting prospective customers “through the door” to purchase goods and services even if those goods and services were not involved with the offer. Other functionality is also contemplated, such as to “push” advertisements to the mobile communication device 104, e.g., advertisements based on the user profile, further discussion of which may be found in relation to the following procedures.

Example Procedures

The following discussion describes loyalty offer techniques that may be implemented utilizing the previously described systems and devices. Aspects of each of the procedures may be implemented in hardware, firmware, software, or a combination thereof The procedures are shown as a set of blocks that specify operations performed by one or more devices and are not necessarily limited to the orders shown for performing the operations by the respective blocks. In portions of the following discussion, reference will be made to the environment 100 and system 200 of FIGS. 1 and 2, respectively.

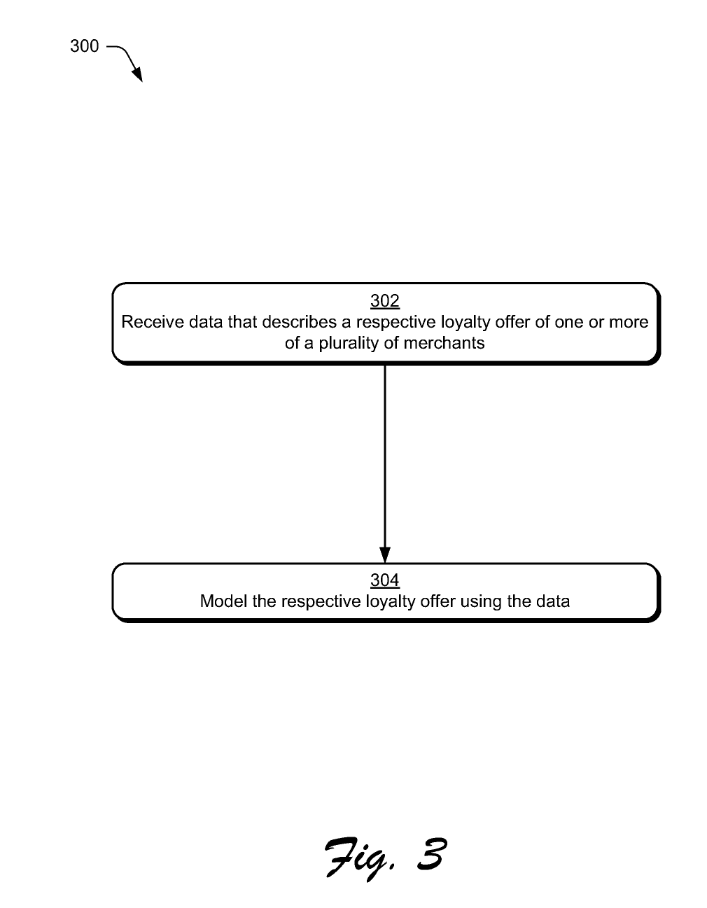

FIG. 3 depicts a procedure 300 in an example implementation in which a user offer is generated by a loyalty service based on data received from a merchant. Data is received that describes a respective loyalty offer of one or more of a plurality of merchants (block 302). The loyalty service 204, for instance, may receive data from a plurality of merchants 202. The data may describe how to model the loyalty offer, such as by specifying a unit of loyalty and a threshold for an action relation to the unit as previously described. A variety of other techniques may also be employed, such as by exposing a user interface that is accessible over the network 108 to model a loyalty offer.

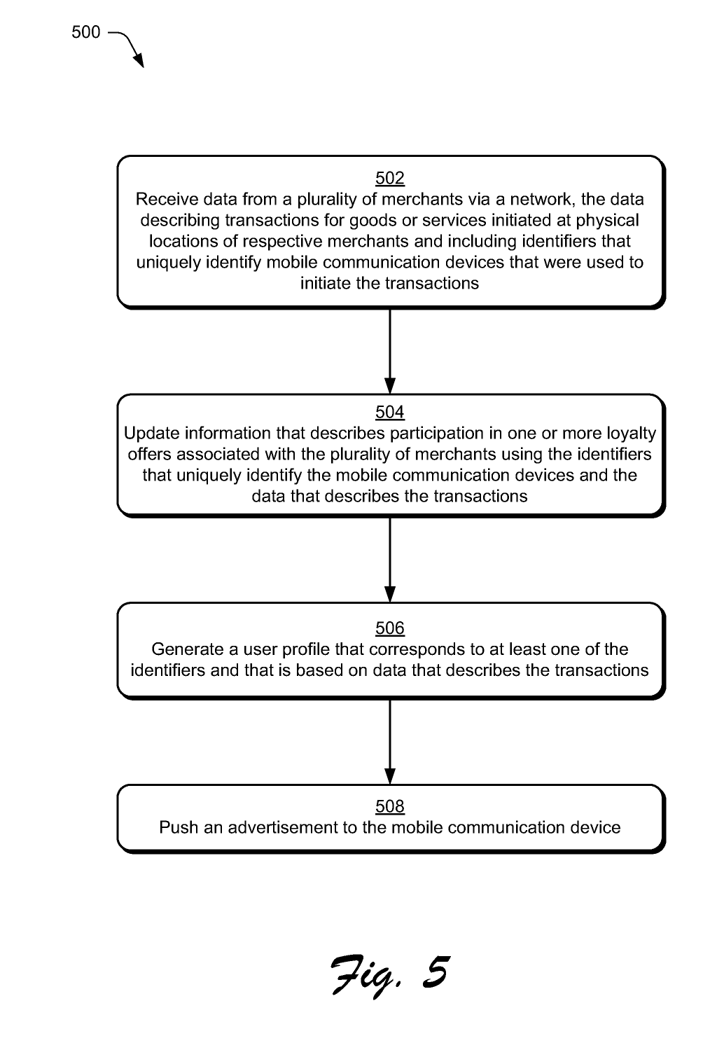

The respective loyalty offer is modeled using the data (block 304). Continuing with the previous example, the loyalty offer 208 may then be modeled based on the data and managed by the loyalty service 204, further discussion of which may be found in relation to FIG. 5.

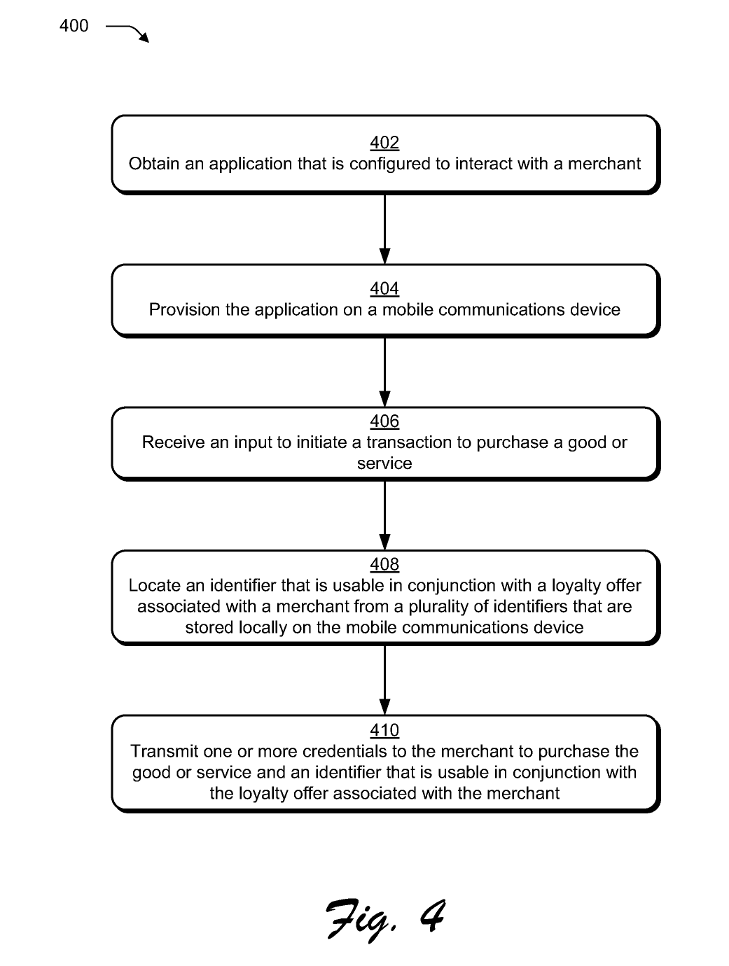

FIG. 4 depicts a procedure 400 in an example implementation in which a mobile communication device provides credentials and an identifier to initiate a purchase of a good or service and participate in a loyalty offer. An application is obtained that is configured to interact with a merchant (block 402). The mobile communication device 104, for example, may navigate over the network 108 to an application store maintained by the application service module 128. The mobile communication device 104 may then select the loyalty application 134 for download for free or for a fee, which may cause the application to be stored locally on the mobile communication device 104 as shown in FIG. 2.

The application is provisioned on the mobile communication device (block 404). The mobile communication device 104, for instance, may leverage the secure element 112 and provisioning service 106 to provision the loyalty application 134, such as to obtain a unique identifier for use by the mobile communication device 104. Other examples are also contemplated, such as to manually input an identifier from a plastic loyalty card obtained by a consumer.

An input is received to initiate a transaction to purchase a good or service (block 406). In an implementation, the mobile communication device 104 may be utilized as an “electronic wallet” to facilitate purchases and participation in the loyalty offers 208. Accordingly, the mobile communication device 104 may communicate credentials with a merchant, e.g., through use of a secure element and near field technology.

An identifier is located that is usable in conjunction with a loyalty offer associated with a merchant from a plurality of identifiers that are stored locally on the mobile communication device (block 408). Continuing with the previous example, the mobile communication device 104 may also leverage the secure element 112 to maintain identifiers to be used in conjunction with a loyalty offer 208. Accordingly, the mobile communication device 104 may locate an identifier that corresponds to the merchant (e.g., via a merchant ID).

One or more credentials are transmitted to the merchant to purchase the good or service and an identifier that is usable in conjunction with the loyalty offer associated with the merchant (block 410). Once the identifier and the credentials (e.g., credit card information) are located, the mobile communication device 104 may provide the credentials and the identifier to the merchant 202 via one or more communications performed using secure techniques. Unsecured techniques are also contemplated without departing from the spirit and scope thereof.

FIG. 5 depicts a procedure 500 in an example implementation in which data that describes participation in a loyalty offer is managed by a loyalty service. Data is received form a plurality of merchants via a network, the data describing transactions for good or services initiated at physical locations of respective merchants and including identifiers that uniquely identify mobile communication devices that were used to initiate the transactions (block 502). As previously described, the identifier may be generated by the loyalty service 204, be assigned to the mobile communication device 104 at manufacture, and so on. Further, the loyalty service 204 may work as a centralized clearinghouse for loyalty offers 208 for a plurality of different merchants 202.

Accordingly, information may be updated that describes participation in one or more loyalty offers associated with the plurality of merchants using the identifiers that unique identify the mobile communication device and the data that describes the transactions (block 504). Thu, the loyalty service 204 may work to outsource loyalty tracking by the merchants 202. The loyalty service 204 may also provide a variety of other functionality.

For example, the loyalty service may be used to generate a user profile that corresponds to at least one of the identifiers and that is based on data that describes the transactions (block 506). In this example, the loyalty service 204 may use the unique identifier to track purchases of goods or services. The identifier may also be used to track presence of the mobile communication device 102 at a physical location of a merchant 202 even if a purchase has not been made, such as by manually scanning the mobile communication device 104 or employing other techniques that may be used to detect the mobile communication device 104 by the merchant. Thus, the loyalty service 204 may generate the user profile to provide a comprehensive view of likes and dislikes of prospective consumers, which may be leveraged to perform a variety of functionality such as to push an advertisement to the mobile communication device (block 508).

Example Device

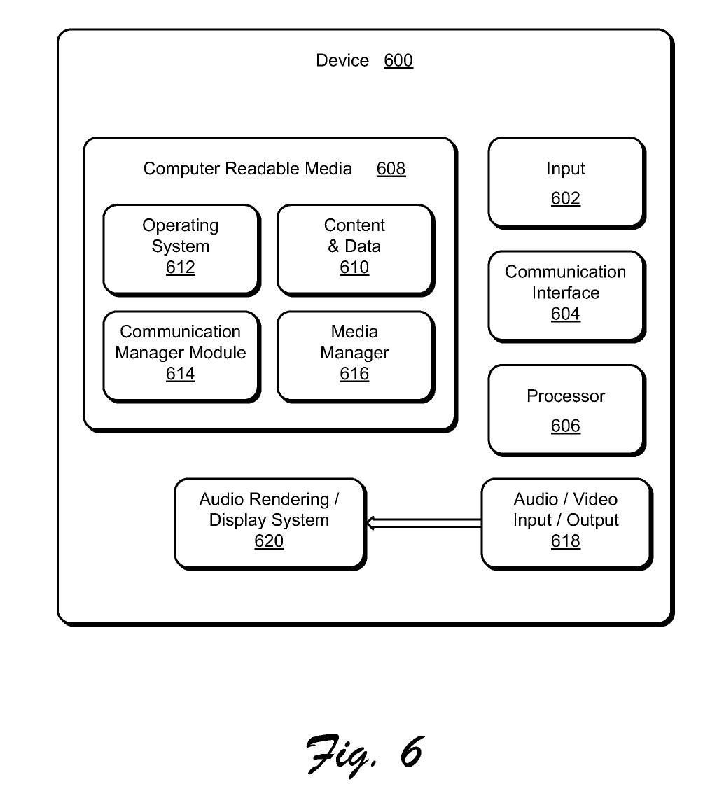

FIG. 6 illustrates various components of an example device 600 that can be implemented in various embodiments as any type of a mobile device to implement embodiments of devices, features, and systems for mobile communications. For example, device 600 can be implemented as any of the mobile communications devices 102 described with reference to respective FIGS. 1-2. Device 600 can also be implemented to access a network-based service, such as a social network service as previously described.

Device 600 includes input 602 that may include Internet Protocol (IP) inputs as well as other input devices, such as the keyboard 112 of FIG. 1. Device 600 further includes communication interface 604 that can be implemented as any one or more of a wireless interface, any type of network interface, and as any other type of communication interface. A network interface provides a connection between device 600 and a communication network by which other electronic and computing devices can communicate data with device 600. A wireless interface enables device 600 to operate as a mobile device for wireless communications.

Device 600 also includes one or more processors 606 (e.g., any of microprocessors, controllers, and the like) which process various computer-executable instructions to control the operation of device 600 and to communicate with other electronic devices. Device 600 can be implemented with computer-readable media 608, such as one or more memory components, examples of which include random access memory (RAM) and non-volatile memory (e.g., any one or more of a read-only memory (ROM), flash memory, EPROM, EEPROM, etc.).

Computer-readable media 608 provides data storage to store content and data 610, as well as device applications and any other types of information and/or data related to operational aspects of device 600. For example, an operating system 612 can be maintained as a computer application with the computer-readable media 608 and executed on processor 606. Device applications can also include a communication manager module 614 (which may be used to provide telephonic functionality) and a media manager 616.

Device 600 also includes an audio and/or video output 618 that provides audio and/or video data to an audio rendering and/or display system 620. The audio rendering and/or display system 620 can be implemented as integrated component(s) of the example device 600, and can include any components that process, display, and/or otherwise render audio, video, and image data. Device 600 can also be implemented to provide a user tactile feedback, such as vibrate and haptics.

Generally, the blocks may be representative of modules that are configured to provide represented functionality. Further, any of the functions described herein can be implemented using software, firmware (e.g., fixed logic circuitry), manual processing, or a combination of these implementations. The terms “module,” “functionality,” and “logic” as used herein generally represent software, firmware, hardware or a combination thereof In the case of a software implementation, the module, functionality, or logic represents program code that performs specified tasks when executed on a processor (e.g., CPU or CPUs). The program code can be stored in one or more computer readable memory devices. The features of the techniques described above are platform-independent, meaning that the techniques may be implemented on a variety of commercial computing platforms having a variety of processors.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by a mobile communication device, the method comprising:
receiving an input to initiate a transaction to purchase a good or service; and
transmitting one or more credentials to a merchant to purchase the good or service and an identifier that is usable in conjunction with a loyalty offer associated with the merchant.

2. A method as described in claim 1, wherein the identifier is unique to the mobile communication device.

3. A method as described in claim 1, wherein the input is received responsive to selection of a portion in a user interface output by the mobile communication device to initiate the transaction.

4. A method as described in claim 3, wherein the user interface is generated at least in part by an application downloaded to the mobile communication device via an Internet and provided by the merchant.

5. A method as described in claim 1, wherein the receiving of the input by the mobile communication device from the merchant and the transmitting of the one or more credentials to the merchant are performed at a physical location of the merchant.

6. A method as described in claim 1, wherein the receiving of the input by the mobile communication device from the merchant and the transmitting of the one or more credentials to the merchant are performed using near field technology.

7. A method as described in claim 1, further comprising locating the identifier that is usable in conjunction with the loyalty offer associated with the merchant from a plurality of said identifiers that are stored locally on the mobile communication device.

8. A method as described in claim 1, wherein the mobile communication device includes telephone functionality to make and receive telephone calls.

9. A method as described in claim 1, further comprising receiving an indication of a discount to be applied to the transaction responsive to the transmitting.

10. A method implemented by one or more servers of a loyalty service, the method comprising:
receiving data from a plurality of merchants via a network, the data describing transactions for goods or services initiated at physical locations of respective said merchants and including identifiers that uniquely identify mobile communication devices that were used to initiate the transactions; and
updating information that describes participation in one or more loyalty offers associated with the plurality of merchants using the identifiers that uniquely identify the mobile communication devices and the data that describes the transactions.

11. A method as described in claim 10, wherein the identifier is generated as part of a respective said loyalty offer.

12. A method as described in claim 10, wherein at least one of the identifiers is also written on a loyalty card provided by a respective said merchant.

13. A method as described in claim 10, wherein the mobile communication devices initiate the transactions by providing credentials that are usable to purchase the goods or services.

14. A method as described in claim 10, further comprising receiving data that describes a respective said loyalty offer of one or more of the plurality of merchants and modeling the respective said loyalty offer using the data.

15. A method as described in claim 10, further comprising generating a user profile that corresponds to at least one said identifier and that is based on the data that describes the transactions.

16. A method as described in claim 15, wherein the user profile describes an effect of an advertisement on purchase of one or more goods or services from one or more said merchants that are not a subject of the advertisement.

17. A method as described in claim 10, further comprising pushing an advertisement to at least one said mobile communication device.

18. A mobile communication device comprising one or more modules that are configured to:
provide telephone functionality including an ability to make and receive telephone calls; and
communicate one or more identifiers at a physical location of a merchant that are to be used to identify participation in one or more loyalty offers associated with the merchant, the one or more identifiers stored locally in memory of the mobile communication device.

19. A mobile communication device of claim 18, wherein the communication of the one or more identifiers is performed using near field technology and is performed in conjunction with one or more credentials that are communicated to the merchant to initiate a purchase of a good or service at the physical location.

20. A mobile communication device of claim 18, wherein the one or more modules are configured to receive advertisements that are pushed by the merchant.
